(19) United States
(12) Patent Application Publication
(10) Pub. No.: US 2007/0076520 A1
(43) Pub. Date: Apr. 5, 2007

(54) Agitator for mixing or agitating target material by rotating vessels containing the material

(76) Inventor: Masakazu Kubo, Osaka (JP)

Correspondence Address: SNELL & WILMER L.L.P.;Attention: Joseph W. Price, Suite 1400, 600 Anton Boulevard, Costa Mesa, CA, 92626, US

(21) Appl. No.: 11/286,952

(22) Filed: Nov. 25, 2005

(30) Foreign Application Priority Data
Oct. 5, 2005 (JP) 2005-291969

(51) Int. Cl. B01F 9/10

(52) U.S. Cl. 366/187; 366/232; 366/235

(57) ABSTRACT

The agitator of the present invention comprises: a drive source; a differential unit; a rotation-direction switching unit; and a brake unit. The drive source generates rotational driving forces. The differential unit and rotation-direction switching unit are positioned in a driving-force transmission path between agitation vessels containing agitation-target material. The brake unit alternately stops the rotation of two rotating shafts extended from the differential unit. Here, the differential unit of the agitator has functions of receiving the rotational driving forces from the drive source and transmitting the rotational driving forces to the two rotating shafts in a differential manner. The rotation-direction switching unit has a function of inverting the rotation direction of the rotational driving forces transmitted to the agitation vessel while the rotation of the rotating shaft is being stopped by a brake.

### BACKGROUND OF THE INVENTION

[1] Field of the Invention

The present invention relates to a mixer for mixing multiple materials and an agitator for agitating or pulverizing one or more types of materials.

[2] Related Art

In the manufacture of chemicals and food products, agitators are generally used for mixing more than one material or pulverizing particulate matter. Some proposed agitators include: ones with a structure in which an agitating screw is provided within a vessel where material such as liquid and powder is poured, and the material in the vessel is agitated by rotating the screw (e.g. Japanese Patent Publication No. 3072467); and ones with a structure in which a screw-free agitation vessel itself, with material contained therein, is rotated, and the rotation direction of the agitation vessel is inverted by reversing the rotation direction of the motor at regular time intervals (e.g. Japanese Laid-Open Patent Application Publication No. 2002-1084). The agitator proposed in the latter reference rotates the agitation vessel while switching the rotation direction in regular intervals, and thereby produces highly efficient agitation of its contained material.

This agitator, proposed in Japanese Laid-Open Patent Application Publication No. 2002-1084 above, does not experience much difficulty in switching the rotation direction of the agitation vessel, which is achieved by switching the rotation direction of the drive source, such as a motor, between forward and reverse, if the agitation vessel and material contained therein have small masses.

In the case when the agitation vessel and contained material have rather large weights, however, inverting the rotation direction of the agitation vessel requires a substantial amount of energy, causing great energy loss, and also results in adding great loads to the motor of the drive source.

### SUMMARY OF THE INVENTION

The present invention has been made in order to solve the above problem, and aims at offering an agitator that (i) achieves rotation of the vessels containing agitation-target material while switching the rotation direction at regular time intervals, and (ii) has low energy loss and exerts reduced loads on itself when switching the rotation direction.

In order to accomplish the above-stated object, the agitator of the present invention adopts the following structure.

The agitator of the present invention comprises: (a) a drive source operable to generate rotational driving forces; (b) a differential unit, having two rotating shafts extending therefrom, operable to receive the rotational driving forces and transmit the received rotational driving forces to the rotating shafts in a differential manner; (c) a brake unit operable to act on each of the rotating shafts and alternately stop the rotating shafts from rotating; (d) a rotation-direction switching unit, coupled to at least one of the rotating shafts, operable to output rotational driving forces from the coupled rotating shaft while switching a rotation direction of the coupled rotating shaft between forward and reverse; (e) an agitation vessel, 1) having therein a containing space for a material to be an agitation target, 2) coupled to the rotation-direction switching unit in a manner that enables input of the output rotational driving forces to the agitation vessel, and 3) having a rotatable structure; and (f) a control unit operable to output, based on a prestored drive sequence, control signals individually to each of the drive source, the differential unit, the brake unit and the rotation-direction switching unit.

The agitator of the present invention with the above characteristic features has the differential unit and brake unit operating based on the control signals sent from the control unit, and therefore, while the brake of one of the two rotating shafts is engaged, the rotational driving forces from the drive source are transmitted to the other rotating shaft in a differential manner. Additionally, the agitator of the present invention has the rotation-direction switching unit coupled to the rotating shaft, and the agitation vessel is coupled to the rotating shaft via the rotation-direction switching unit. Hence, the agitator of the present invention is capable of switching the rotation direction in a condition where the rotation is being stopped by applying the brake to the rotating shaft, and also capable of rotating the agitation vessel in the inverse direction from the rotation before the brake application by releasing the brake after the rotation direction is switched. Thus, the agitator of the present invention inverts the rotation direction of the agitation vessel without inverting that of the motor of the drive source each time, unlike the agitator proposed in Japanese Laid-Open Patent Application Publication No. 2002-1084.

Accordingly, the agitator of the present invention is able to rotate the vessel containing therein agitation-target material at regular time intervals while switching the rotation direction, and also has advantageous effects of obtaining low energy loss and exerting reduced loads on itself when switching the rotation direction.

The agitator of the present invention is able to adopt the following variations.

The agitator of the present invention is able to adopt a structure in which each of the rotating shafts is associated with a different one of rotation-direction switching units and a different one of agitation vessels. That is, the agitator comprises two or more agitation vessels, and these agitation vessels can be rotated using the rotational driving forces derived from a single drive source.

The agitator of the present invention is also able to adopt a structure in which the control unit transmits, to one of the rotation-direction switching units which is coupled to one of the rotation shafts whose rotation is being stopped by the brake unit, a control signal for causing the coupled rotation-direction switching unit to switch the rotation direction of the coupled rotation shaft between forward and reverse while the rotation is being stopped.

The agitator of the present invention is also able to adopt a structure in which the differential unit allocates the rotational drive forces from the drive source for the rotating shafts in proportion to loads exerted on the rotating shafts, and transmits the allocated rotational driving forces to each of the rotating shafts.

The agitator of the present invention is also able to adopt a following structure: in the agitation vessel, a dimple process is applied to an internal surface of the agitation vessel, surrounding the containing space. Thus, adopting the agitation vessels, to the internal surfaces of which the dimple process is applied, enables highly efficient agitation.

The agitator of the present invention is also able to adopt a following structure: in the agitation vessel, a discharge path is formed outwardly from a section, and a vicinity thereof, within an internal surface surrounding the containing space, the section lying, in a radial direction of rotation, furthest from a central axis of rotation. Adopting agitation vessels having such a structure allows the following advantageous effects to be obtained.

As to the agitator of the present invention adopting agitation vessels each having the above structure, even if the agitation vessels contain inside highly viscous material, it is possible to smoothly collect the fluid material to the outside of the agitation vessels by rotating the agitation vessels so as to apply, to the fluid material, centrifugal force that is larger than gravity. The agitator of the present invention achieves reliable collection regardless of the viscosity of the fluid material by setting the number of rotations of the vessels according, for example, to: the viscosity of material contained in the agitation vessels; the period of time that can be devoted for the collection; and an allowable amount of the material remaining in the vessels after the collection.

In each agitation vessel of the agitator according to the present invention, internal apertures of discharge paths are provided at a section, including the vicinity, furthest from the central axis of rotation in the radial direction of rotation, as described above. This structure is adopted because, when rotational motion is applied to the contained material by rotating the vessel, the fluid material is collected at the section where the internal apertures are provided.

Accordingly, the agitator of the present invention adopting the above agitation vessels is capable of reducing the amount of material remaining in the agitation vessels, regardless of the viscosity of the contained material, and is also effective to reduce the number of processes required for cleaning the inside of the vessels.

The agitator of the present invention is also able to adopt a structure in which the containing space is substantially spherical, and the discharge path is formed outwardly from an equator of rotation, and a vicinity thereof, on the internal surface surrounding the containing space.

The agitator of the present invention is also able to adopt a structure in which a valve operating mechanism operable to open and close the discharge path is positioned in the discharge path.

The agitator of the present invention is also able to adopt a structure in which a guide cover for collecting the material discharged from the discharge path due to rotation of the agitation vessel is positioned, at or in a vicinity of an outer circumference of the agitation vessel, so as to correspond to an outer end of the discharge path.

The agitator of the present invention may further comprise a collection container operable to rotate in synchronization with the agitation vessel and collect the material discharged from the discharge path, and the guide cover is rotatable in synchronization with both the agitation vessel and the collection container.

The agitator of the present invention which has an agitation vessel operable to contain a plurality of materials is applicable to a drive mode in which the plurality of materials contained in the agitation vessel are agitated due to rotation of the agitation vessel.

The agitator of the present invention which has an agitation vessel operable to contain granular or aggregated material is applicable to a drive mode in which the granular or aggregated material contained in the agitation vessel is pulverized due to rotation of the agitation vessel.

### BRIEF DESCRIPTION OF THE DRAWINGS

These and other objects, advantages and features of the invention will become apparent from the following description thereof taken in conjunction with the accompanying drawings which illustrate specific embodiments of the invention. In the drawings:

FIG. 1 is a schematic diagram showing a structure of an agitator 1000 according to Embodiment 1;

FIG. 2 is a time chart for describing operation of the agitator 1000;

FIG. 3 is a schematic diagram showing a structure of an agitator 2000 according to Embodiment 2;

FIG. 4 is a lateral view (with a partially cutaway cross sectional view) showing structures of an agitation vessel 32 a and a collection ring 34a of the agitator 2000;

FIG. 5A is a schematic cross section showing a state in which liquid 50 is contained in the agitation vessel 32a of the agitator 2000;

FIG. 5B is a schematic cross section showing a state in which the liquid 50 is being collected from the agitation vessel 32a of the agitator 2000; and

FIG. 6 is a lateral view (with a partially cutaway cross sectional view) showing structures of the agitation vessel 32a and a collection assist device 35a, which are characteristic components of an agitator 3000 according to Embodiment 3.

### DESCRIPTION OF PREFERRED EMBODIMENTS

The best modes for implementing the present invention are described next with the aid of drawings. Note that embodiments described hereinafter are merely examples for illustrating in a straightforward manner the structural characteristics and advantageous effects resulting from the structures of the present invention. Therefore, the present invention is not limited to the following embodiments, except for the technical features.

1. Embodiment 1

1.1 Structure

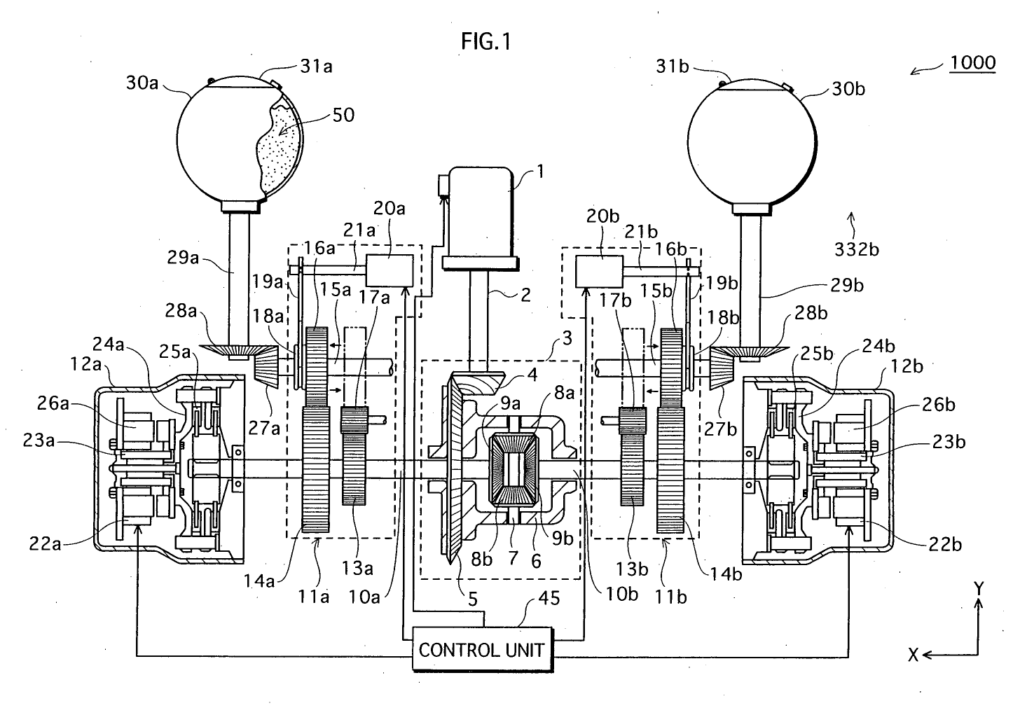

The overall structure of an agitator 1000 according to the present embodiment is described below with the aid of FIG. 1.

As shown in FIG. 1, the agitator 1000 of the present embodiment comprises: a drive motor 1 for supplying rotational driving forces; and two agitation vessels 30a and 30b. The drive motor 1 is connected to a differential block 3 by a driving shaft 2. Extended from the differential block 3 are two rotating shafts 10a and 10b, both of which are connected to rotation-direction switching blocks 11a and 11b, respectively.

Each rotating shaft 10a/10b is provided in a manner to penetrate and protrude through the rotation-direction switching block 11a/11b, and a brake block 12a/12b is positioned at the other end of each rotating shaft 10a/10b. A rotating shaft 15a/15b extends through the rotation-direction switching block 11a/11b, and is connected to the agitation vessel 30a/30b via a rotating shaft 29a/29b and others. The agitation vessels 30a and 30b adopted in the agitator 1000 of the present embodiment are hollow and roughly spherical. As to these agitator vessels 30a and 30b, intake lids 31a and 31b are respectively mounted to block off the openings at the upper parts, and liquid 50 is retained in the substantially spherical containing spaces.

Additionally, the agitator 1000 further comprises a control unit 45 for executing the drive control. The control unit 45 performs the drive control based on a drive program prestored in a memory (not shown) within the unit.

The differential block 3 has a publicly-known structure similar to one used for a drive system of passenger automobiles and the like, and includes: a ring gear 5; a case 6; a pinion shaft 7; differential pinions 8a and 8b; side gears 9a and 9b. To the driving shaft 2 extending from the drive motor 1, a drive pinion 4 is attached at the end and engages with the ring gear 5. One end of each rotating shaft 10a/10b is joined to the side gear 9a/9b. The differential block 3 transmits, to the two rotating shafts 10a and 10b, the driving force from the driving shaft 2 in a differential manner.

The rotation-direction switching blocks 11a and 11b are respectively connected to the two rotating shafts 10a and 10b joined to the differential block 3, and each includes: large-diameter gear 14a/14b; gears 13a/13b and 16a/16b each having a smaller diameter than the large-diameter gear 14a/14b; and a small gear 17a/17b. To the rotating shaft 15a/15b supporting the gear 16a/16b, a spool-shaped ring 18a/18b is attached in a manner that does not come in direct contact with the rotating shaft 15a/15b. Attached to each ring 18a/18b is a bifurcated lever 19a/19b connected to an electromagnetic solenoid 20a/20b via an operating shaft 21a/21b.

Here, each lever 19a/19b is capable of moving in the X direction in FIG. 1 due to the drive of the electromagnetic solenoid 20a/20b based on a control signal from the control unit 45. With this movement, the lever 19a/19b shifts the gear 16a/16b in the horizontal direction via the ring 18a/18b. Because of the shifting motion, in the rotation-direction switching block 11a/11b, the gear 16a/16b engages with either the gear 14a/14b or the gear 17a/17b.

The rotational driving forces derived from each rotating shaft 15a/15b, to which the gear 16a/16b is joined, are transmitted to the rotating shaft 29a/29b via the gear 27a/27b and the gear 28a/28b. The agitation vessel 30a/30bis joined to the rotating shaft 29a/29b at the end.

The brake blocks 12a and 12b are electromagnetic disc brakes, and each is positioned at the end of the rotating shaft 10a/10b extending from the differential block 3. Specifically speaking, the brake block 12a/12b includes: an electromagnetic coil 22a/22b; a spring 23a/23b; a disc 24a/24b; a pad 25a/25b; and a core 26a/26b. The brake blocks 12a and 12b alternately stop the rotation of the rotating shafts 10a and 10b based on an indication signal from the control unit 45. When a current is made to flow to the electromagnetic coil 22a/22b based on the control signal from the control unit 45, the disc 24a/24b is pulled toward the core 26a/26b against the force of the spring 23a/23b, and the disc 24a/24b is then separated from the pad 25a/25b to thereby release the brake. Note that, when a current is not flowing through the electromagnetic coil 22a/22b, the inverse operation from the one described above is performed to engage the brake.

1.2 Driving Method of Agitator 1000

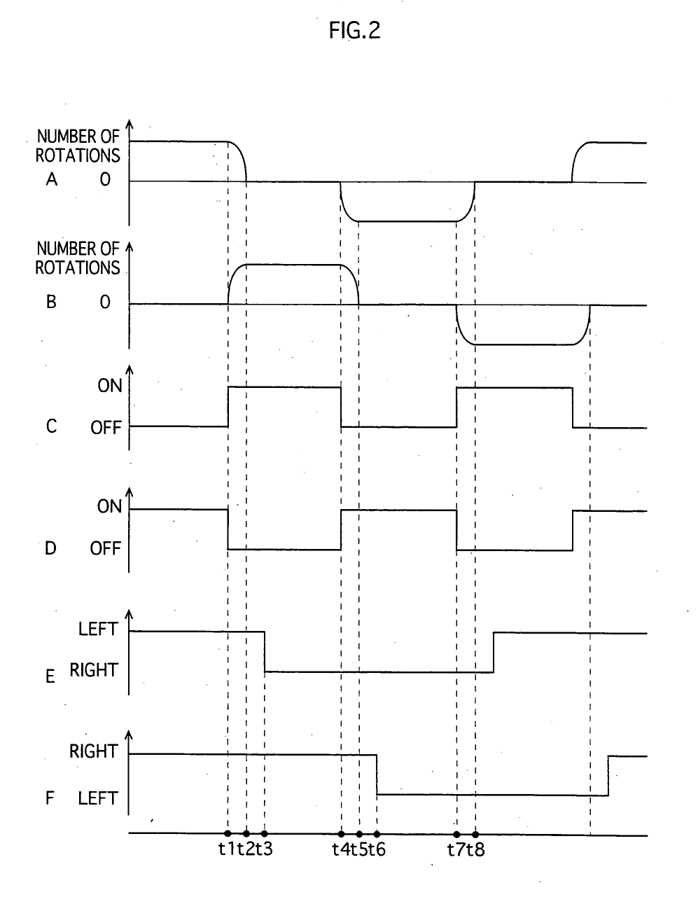

The driving method of the agitator 1000 having the above structure is described next with the aid of FIG. 2.

In FIG. 2, individual sections (A to F) show the following: A) the rotation condition of the agitation vessel 30a; B) the rotation condition of the agitation vessel 30b; C) brake voltage applied to the brake block 12a; D) brake voltage applied to the brake block 12b; and E) and F) voltage for switching the rotation direction.

For driving the agitator 1000, as shown in FIG. 2, the liquid 50 is first fed into the agitation vessels 30a and 30b, and the intake lids 31a and 31b are closed. Then, prior to the drive motor 1 being driven, a control voltage is applied to the brake blocks 12a and 12b from the control unit 45 to thereby set the brake block 12a to an OFF state (the brake being released) and set the brake block 12b to an ON state (the brake being engaged). In this state of things, the rotational drive of the drive motor 1 is started by applying an operation-start signal to the drive motor 1 from the control unit 45.

In the condition described above, since the brake of the brake block 12b is engaged, the rotating shaft 10b does not rotate, while only the rotating shaft 10a starts its rotation. Then, the rotating shaft 29a is made to rotate via the gear 16a and rotating shaft 15a in the rotation-direction switching block 11a as well as via the gears 27a and 28a. As a result, the agitation vessel 30a, as shown on the left side of FIG. 1, starts rotating at a predetermined number of rotations.

In the agitator 1000, after the above drive state is carried on for a certain period of time, the brake voltage from the control unit 45 is switched at timing t1, as shown in FIG. 2. That is, the brake of the brake block 12a is engaged, while the brake of the brake block 12b being released. Subsequently, the agitation vessel 30a stops rotating at timing t2, as shown in the section A of FIG. 2. On the other hand, as shown in the section B of FIG. 2, the agitation vessel 30b starts its rotation at timing t1, and reaches a steady drive state at timing t2. As shown in the section E of FIG. 2, a voltage is applied to the electromagnetic solenoid 20a from the control unit 45 at timing t3, and the gear 16a shifts rightward to engage with the gear 17a. Now, the agitation vessel 30a is poised to invert its rotation. As shown in the sections C and D of FIG. 2, the brake voltage is switched at timing t4, and the brake is applied to the agitation vessel 30b. Then, the rotation of the agitation vessel 30b subsequently stops at timing t5. On the other hand, the agitation vessel 30a starts rotating in the inverse direction, and then reaches the steady drive state at timing t5. As shown in the section F of FIG. 2, the control unit 45 applies a voltage to the electromagnetic solenoid 20b at timing t6, and the gear 16b shifts leftward in FIG. 1 to engage with the gear 17b. Thus, the agitation vessel 30b is now poised to invert its rotation. From here onward, the rotation direction is switched at timings t7 and t8 in a similar fashion. Note that, as long as timing t3 is established between timings t2 and t4 and timing t6 is established between timings t5 and t7, the occurrences of timings t3 and t6 are not limited to the case shown in FIG. 2.

1.3 Advantageous Effects In the agitator 1000 of the present embodiment, as described above, the agitation vessels 30a and 30b rotate alternately—that is, when one agitation vessel is rotating, the other is in a stopped state. Then, when the agitation vessel currently in the stopped state starts its rotation, it will rotate in the inverse direction from the previous rotation. In the agitator 1000 of the present embodiment, as can be seen from a series of these movements, the rotating shaft 2 of the drive motor 1 is always rotating in only one direction. Thus, although the rotation directions of the agitation, vessels 30a and 30b are alternately switched between forward and reverse, there is no need to switch the rotation direction of the drive motor 1, which results in significantly high efficiency. Such movements being feasible is attributed to the operation of the differential block 3, and the energy loss is reduced since the rotation of one rotating shaft 10a (10b) accelerates when the rotation of the other rotating shaft 10b (10a) slows down.

The agitator 1000 of the present embodiment is capable of mixing food products and chemicals, for example. In the case of mixing food products, the contained food is free from damage during the agitation because the agitation vessels 30a and 30b of the agitator 1000 do not have therein blades or the like.

2. Embodiment 2

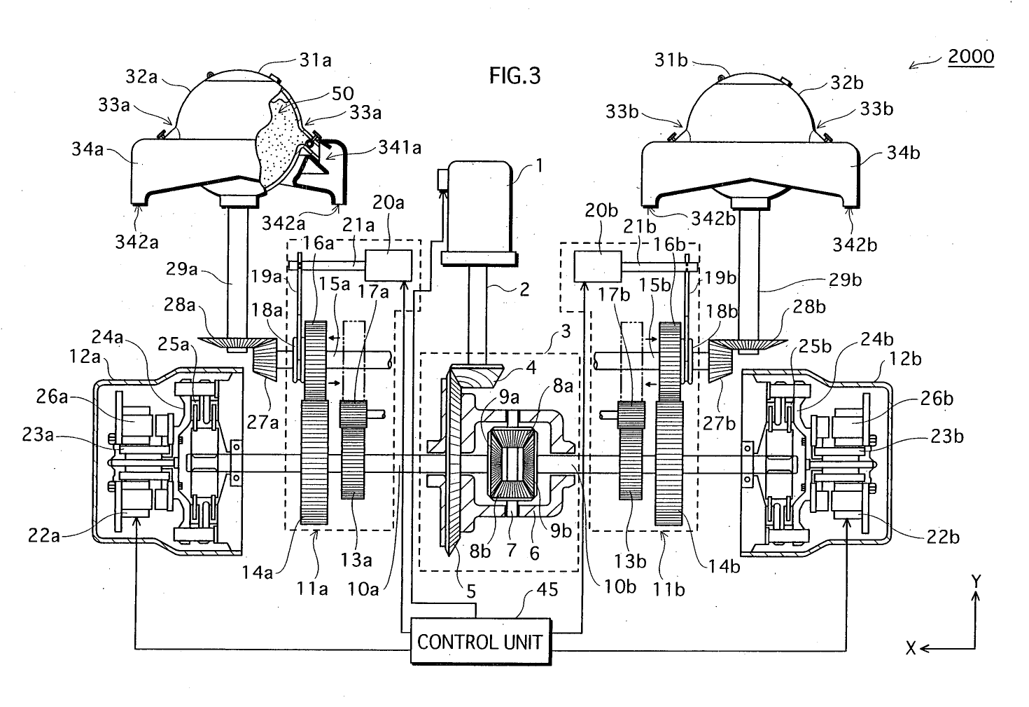

Next, an agitator 2000 according to Embodiment 2 of the present invention is described with the aid of FIGS. 3 to 5. Note that, in the following explanation, the same numerical symbols are used for the same components as in the agitator 1000 of Embodiment 1, and the descriptions of these components are omitted here.

2.1 Structure

The basic structure of the agitator 2000 of the present embodiment is, as shown in FIG. 3, the same as that of the agitator 1000 of Embodiment 1 above. Different characteristics of the agitator 2000 of the present embodiment, as compared to the above agitator 1000, are the configuration of agitation vessels 32a and 32b and attachments (i.e. collection rings 34a and 34b) positioned at the outer circumferences of the agitation vessels 32a and 32b. The following gives an account focusing on the differences of the agitator 2000 from the agitator 1000.

As shown in FIG. 3, the agitator 2000 of the present embodiment includes two agitation vessels 32a and 32b, on each of which two discharge nozzles 33a/33b are formed at the equator to face outward in the radial direction. Additionally, the agitator 2000 has collection rings 34a and 34b that are positioned to surround the outer circumferences of the agitation vessels 32a and 32b, respectively.

In each collection ring 34a/34b, a receiving opening 341a is formed throughout the entire circumference, at a location corresponding to the discharge nozzles 33a/33b provided on the agitation vessel 32a/32b. The receiving opening 341a receives the liquid 50 discharged from the discharge nozzles 33a/33b of each rotating agitation vessel 32a/32b. Note that the collection rings 34a and 34b remain stationary and do not rotate with the agitation vessels 32a and 32b in a rotating motion. In addition, the collection rings 34a and 34b and the like are fixed onto stationary portions of the agitator 2000—such as base plates and base frames—by support frames although this is not shown in FIG. 3 and other figures.

At the lower portion, in the Z direction, of each collection ring 34a/34b, two discharge outlets 342a/342b are formed on the periphery. The liquid 50 received from the receiving opening 341a is collected to the two discharge outlets 342a/342b by the collection ring 34a/34b functioning as a guide cover. In the actual collection process, collection containers are placed below the discharge outlets 342a/342b of the collection ring 34a/34b to receive the collected liquid 50.

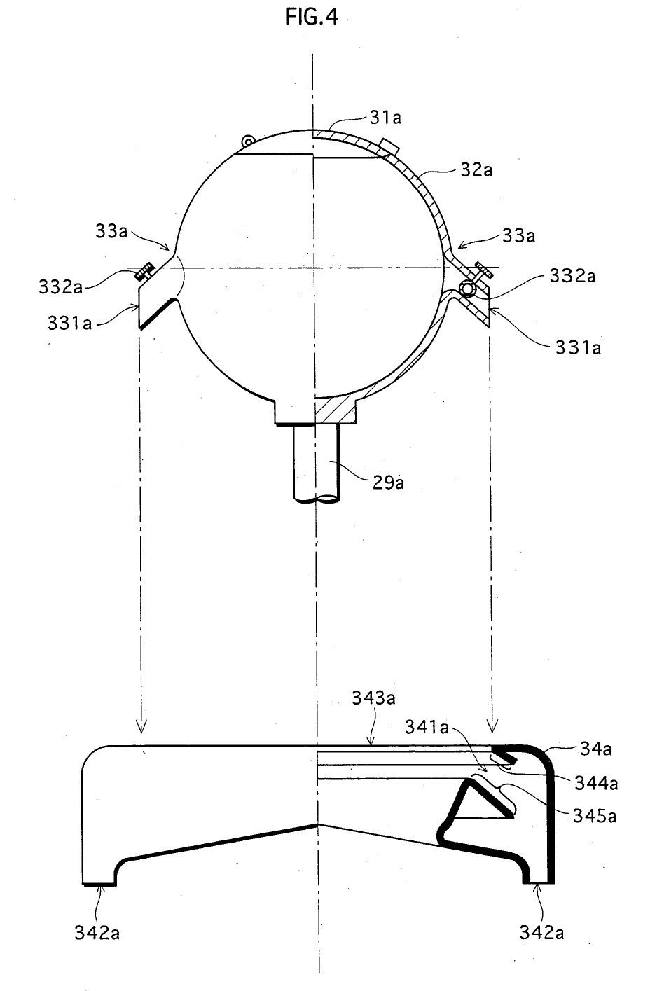

As shown in FIG. 4, within each discharge nozzle 33a provided on the equator of the agitation vessel 32a, a ball valve 332a is positioned in the discharge path. When the liquid 50 is agitated using the agitator 2000, the ball valve 332a is closed to avoid spillage, while the ball valve 332a is opened when the liquid 50 is collected.

The collection ring 34a is, as described above, positioned to surround the outer circumference of the agitation vessel 32a, and part of the agitation vessel 32a is inserted into an aperture 343a of the collection ring 34a, created in the middle section. Additionally, the receiving opening 341a is formed to correspond to the discharge nozzles 33a when the agitation vessel 32a is inserted thereto. Inside the collection ring 34a, guide edges 344a and 345a are formed in order to prevent the liquid 50 from splashing between the receiving opening 341a and the discharge outlets 342a. These guide edges 344a and 345a are formed inside the collection ring 34a along the entire circumference.

Note that FIG. 4 shows only one of two agitation vessels 32a and 32b as well as one of two collection rings 34a and 34b provided in the agitator 2000—i.e. the agitation vessel 32a and the collection ring 34a shown on the left side of FIG. 3, however, the other agitation vessel 32b and collection ring 34b also have the same structures as their counterparts, respectively.

2.2 Collection Operation of Liquid 50 from Agitation Vessels 32a and 32b, and Advantageous Effects of Agitator 2000

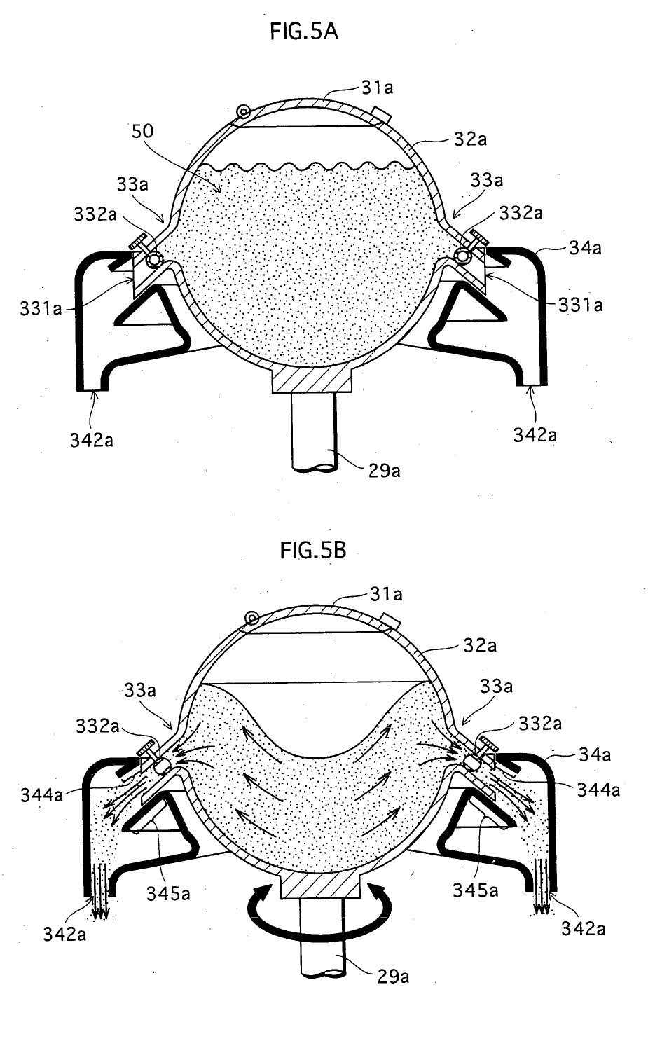

When the ball valves 332a of the discharge nozzles 33a are closed, the liquid 50 is held inside the agitation vessel 32a, as shown in FIG. 5A. This configuration is used when the agitator 2000 carries out the agitation operation. The intake lid 31a is also closed tight before the agitation operation to prevent the liquid 50 from splashing out of the agitation vessel 32a.

Then, when the liquid 50 in the agitation vessel 32a is collected, collection containers (not shown in FIG. 5B) are first placed below the discharge outlets 342a of the collection ring 34a, and the ball valves 332a are opened, as shown in FIG. 5B. The agitation vessel 32a is subsequently set in rotation by starting the drive motor 1 of the agitator 2000. By using centrifugal force derived from this rotation, the liquid 50 is collected to the collection containers from the discharge nozzles 33a via the collection ring 34 a.

In the collection process of the liquid 50, since the guide edges 344a and 345a are provided inside the collection ring 34a, the liquid 50 discharged, from nozzle openings 331a, in the normal direction under centrifugal force is guided to the collection containers by these guide edges 344a and 345a.

On the agitation vessel 32a of the agitator 2000 according to the present embodiment, the discharge nozzles 33a are formed outwardly at the equator of the rotation operation being performed. It is designed to have the discharge nozzles 33a within the section where the largest portion of the liquid 50 under centrifugal force is distributed, and therefore the liquid 50 in the agitation vessel 32a is smoothly discharged in a reliable manner. The other agitation vessel 32b and the collection ring 34b attached thereto have the same operational and collection mechanisms as their counterparts, respectively.

As to the agitator 2000 of the present embodiment, therefore, it is less likely that the liquid 50 remains inside the agitation vessels 32a and 32b during the collection, which allows to eliminate or reduce the need for cleaning for an operation following the current collection operation. Although the number of rotations of the agitation vessels 32a and 32b for the collection of the liquid 50 in the agitator 2000 is arbitrarily set according, for instance, to the viscosity of the liquid 50 contained therein and the operating time that can be devoted for the collection, several dozen times per minute, for example, should suffice. Here, in the case if part of the liquid 50 still remains at the inside bottom of the agitation vessels 32a and 32b in the final step of the collection operation, the number of rotations of the agitation vessels 32a and 32a may be slightly increased correspondingly.

The description of the drive method of the agitator 2000 in relation to the agitation is left out since the method is essentially the same as that of the agitator of Embodiment 1 above. However, because of adopting the structure described above, the agitator 2000 is able to switch the rotation directions of the agitation vessels 32a and 32a between forward and reverse without changing the rotation direction of the drive motor 1 (the source of power) between forward and reverse. Namely, for driving the agitator 2000: 1) the drive motor 1 is started; 2) while the drive motor 1 is in the driving state, one of the brake blocks 12a and 12b is activated to thereby stop the rotation of one of the rotating shafts 10a and 10b extending from the differential block 3; 3) during this time, the rotation-direction switching block (11a or 11b) connected to the stopped rotating shaft (10a or 10b) is set in motion, and herewith the rotation direction of the rotating shaft (29a or 29b) is switched. Thus, although the brake is applied to one rotating shaft (10a or 10b) to thereby keep the rotation in the stopped state, rotational driving forces are continuously transmitted to the other rotating shaft (10a or 10b) due to the function of the differential block 3, which is a differential unit.

Therefore, by alternately applying a series of the above operation to two rotating shafts 10a and 10b, the agitator 2000 is able to alternately invert the rotation directions of the agitation vessels 32a and 32a while maintaining the rotation derived from the drive motor 1—i.e. the rotation of the driving shaft 2—steadily in a single direction. As a result, highly efficient agitation operation can be achieved. Furthermore, the agitator 2000 has advantageous effects in terms of a reduction in loads exerted on the drive motor 1 and shafts 2, 10a, 10b, 29a and 29b.

3. Embodiment 3

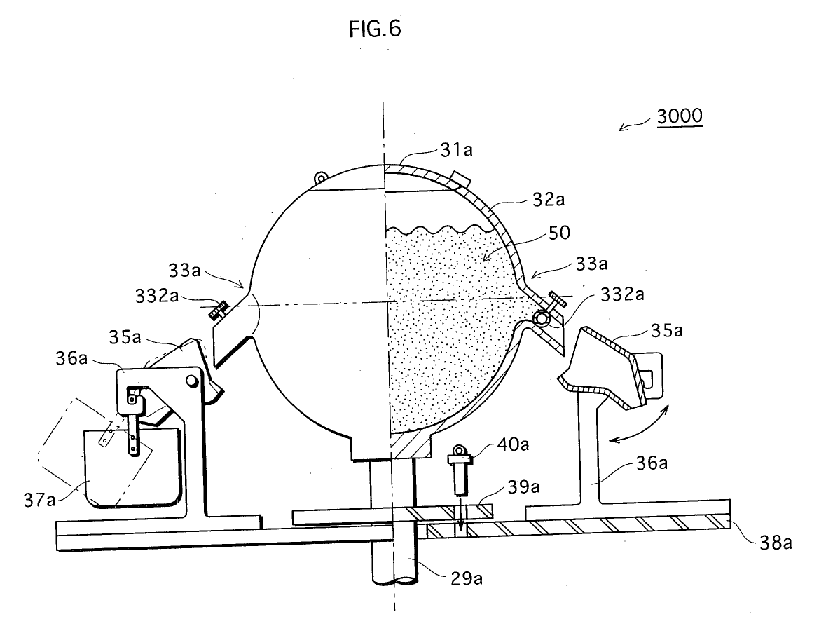

Next, the structure of an agitator 3000 according to Embodiment 3 is described with the aid of FIG. 6. Note that all the components of the agitator 3000 of the present embodiment are the same as those of Embodiment 2 above, except for guide cover portions accompanying the agitation vessels 32a and 32b, and thus a figure and a description regarding the structure of the agitator 3000 are left out here.

Unlike Embodiment 2 above, the agitator 3000 of the present embodiment does not have the collection ring 34a, surrounding the entire outer circumference of the agitation vessel 32a. Instead, collection containers 37a are positioned so as to correspond to the respective discharge nozzles 33a provided on the agitation vessel 32a, as shown in FIG. 6. In addition, between each pair of the discharge nozzle 33a and the collection container 37a, a funnel-shaped collection assist device 35a is positioned to ensure guiding the discharged liquid 50 into the collection container 37a

Each paired collection container 37a and collection assist device 35a are, individually, rotatably supported around an axis of rotation by a collection-container support frame 35a arranged in a standing manner on a disc-shaped collection-container base plate 38a. In the agitator 3000 of the present embodiment, a vessel base plate 39a, having a smaller diameter than the collection-container base plate 38a, is joined to the rotating shaft 29a which is joined to the agitation vessel 32a.

The collection-container base plate 38a and vessel base plate 39a can be engaged with each other by inserting a lock pin 40a into a hole provided in each plate. When these plates are engaged together by the insertion of the lock pin 40a, the agitation vessel 32a, collection containers 37a and collection assist devices 35a rotate in synchronization with one another due to the rotation of the rotating shaft 29a. The holes in the collection-container base plate 38a and vessel base plate 39a for the insertion of the lock pin 40a are arranged so that the collection assist devices 35a are positioned at the outlets of the discharge nozzles 33a when the plates are engaged with each other.

During the collection of the liquid 50 using the agitator 3000, the vessel base plate 39a and collection-container base plate 38a are engaged with each other by the inserted lock pin 40a, and then the agitation vessel 32a, collection containers 37a and collection assist devices 35a is made to rotate in synchronization with one another by setting the rotating shaft 29 in rotation. Subsequently, the liquid 50 is collected to the collection containers 37a due to centrifugal force of the rotation. The collection containers 37a and collection assist devices 35a each are designed to change their angles with the rotation of the rotating shaft 29a, as shown in FIG. 6. Herewith, the liquid 50 discharged from the discharge nozzles 33a is collected to the collection containers 37a without splashing outside.

The agitator 3000 also has another agitation vessel 32b, as in the case of the agitator 2000 according to Embodiment 2. The other agitation vessel 32b as well as the collection containers 37a and collection assist devices 35a accompanying thereto all have the same structures as their counterparts, respectively.

The agitator 3000 of the present embodiment achieves the same advantageous effects as the agitator 2000 of Embodiment 2 above. In addition, unlike Embodiment 2 above, the agitator 3000 of the present embodiment does not have the collection rings 34a, and 34b surrounding the entire outer circumferences of the agitation vessels 32a and 32a. The collection assist devices 35a are provided at only positions corresponding to the respective discharge nozzles 33a. As a result, even if the collection assist devices 35a and the like need to be cleaned after every cycle of agitation and collection, it is possible to reduce the number of processes required for the cleaning.

4. Additional Particulars

Although, in the agitators 2000 and 3000 according to Embodiments 2 and 3 above, two discharge nozzles 33a and 33bare formed on each of the agitation vessels 32a and 32b, the number of discharge nozzles 33a and 33b are not confined to the case. Only one discharge nozzle, or alternatively three or more discharge nozzles may be provided for each agitation vessel, instead. Additionally, in Embodiments 2 and 3 above, the ball valves 332a are fitted in the discharge nozzles 33a and 33b, however, a structure other than this can be adopted if it allows to control retention and discharge of the liquid 50. For example, the following structure may be adopted: more than one aperture is created on the equator of the agitation vessel 32a; then, when the liquid 50 is retained inside, such as during the agitation process, ring bodies are fit tightly around the outer circumferences of the agitation vessels 32a and 32b so as to block off each aperture. On the other hand, when the liquid 50 is collected, the multiple apertures can be opened at once by taking the ring bodies off, which reduces the number of processes required for the collection process.

The agitator 1000 of Embodiment 1 has two agitation vessels 30a and 30b, while each of the agitators 2000 and 3000 of Embodiments 2 and 3 has two agitation vessels 32a and 32b. However, an agitator having three or more agitation vessels is also within the scope of the present invention. Additionally, in Embodiments 1 to 3, the liquid 50 is poured in each of the agitation vessels 30a, 30b, 32a and 32b to perform the agitation process, however, the agitation process may be carried out with one of the two agitation vessels empty (i.e. containing no liquid 50).

The agitators 1000 to 3000 of Embodiments 1 to 3 above have a structure in which the center of the containing space of each agitation vessel 30a and 32a/30b and 32b lies on the axis of the rotating shaft 29a/29b; however, it is not always necessary to adopt this structure.

In Embodiments 1, 2 and 3 above, the agitators 1000, 2000 and 3000 are used as examples of usage of containers for fluids; however, the present invention can also use other types of containers. For instance, the present invention may apply containers used for retaining food products, chemicals, cosmetics or the like therein. Specifically speaking, such containers include: ones for keeping viscous cosmetics, such as cosmetic creams and liquid foundations, and materials of these; and ones for preserving food products such as fermented soybean paste and ketchup.

As to the fluid containers of the agitators of the present invention (i.e. the agitation vessels 30a, 30b, 32aand 32b), the dimple or a groove process may be applied to their internal surfaces. Note, however, that it is desirable not to inhibit the transfer of the fluid material to the discharge paths during the collection process. Additionally, in Embodiments 1 to 3 above, the outer shape of each agitation vessel 30a/30b/32a/32b and the shape of its internal, containing space are both spherical. However, regarding the fluid containers of the present invention, the outer shape and the shape of the internal containing space are not limited to spherical. For example, both the outer shape and the internal containing space may be cylindrical or conical. In addition, the internal containing space and the outside appearance do not necessarily have the same shape—e.g. the internal containing space is spherical while the outer shape is columnar or cubic. Furthermore, 5-gallon cans or drums can be used for the agitation vessels 30a, 30b, 32a and 32b.

In the agitators 1000 to 3000 of Embodiments 1 to 3 above, the drive motor 1 using electric power as a source of energy is given as an example of a source of power, however, other means that produces rotational drive—e.g. a gasoline engine and a gas-turbine engine—may be used, instead. Additionally, although electromagnetic disc brakes are adopted as the brake blocks 12a and 12b in the agitator 1000 of Embodiment 1, other structures can be employed. For instance, electro-hydraulic disc brakes or retarder systems using magnetic forces may be applied. The rotation-direction switching blocks 11a and 11b are also not limited to the structures adopted in the embodiments above.

In addition, the agitation target of the agitator of the present invention is not limited to the liquid 50, which is used as an example in Embodiments 1 to 3 above, and any fluid material may be used for the target. The same effects can be achieved with not only liquid in a gel or sol state but also powder as well as a mixture of liquid and solid materials, for example. Furthermore, the agitators 1000 to 3000 can be used as pulverizers. Here, ceramic materials already pulverized to some extent are placed in and agitated to achieve finer pulverization. In this case, the efficiency of the pulverization will be enhanced by adding thereto a number of hard balls made of a different material.

Thus, the agitator of the present invention has a great range of applications, such as mixing, pulverizing, and simple agitation. Note that the term “agitation” cited in this specification has a broad sense—including agitation for mixing and for pulverization.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

What is claimed is:

1. An agitator comprising:
a drive source operable to generate rotational driving forces;
a differential unit, having two rotating shafts extending therefrom, operable to receive the rotational driving forces and transmit the received rotational driving forces to the rotating shafts in a differential manner;
a brake unit operable to act on each of the rotating shafts and alternately stop the rotating shafts from rotating;
a rotation-direction switching unit, coupled to at least one of the rotating shafts, operable to output rotational driving forces from the coupled rotating shaft while switching a rotation direction of the coupled rotating shaft between forward and reverse;
an agitation vessel, (i) having therein a containing space for a material to be an agitation target, (ii) coupled to the rotation-direction switching unit in a manner that enables input of input the output rotational driving forces to the agitation vessel, and (iii) having a rotatable structure; and
a control unit operable to output, based on a prestored drive sequence, control signals individually to each of the drive source, the differential unit, the brake unit and the rotation-direction switching unit.

2. The agitator of claim 1, wherein
each of the rotating shafts is associated with a different one of rotation-direction switching units and a different one of agitation vessels.

3. The agitator of claim 2, wherein
the control unit transmits, to one of the rotation-direction switching units which is coupled to one of the rotation shafts whose rotation is being stopped by the brake unit, a control signal for causing the coupled rotation-direction switching unit to switch the rotation direction of the coupled rotation shaft between forward and reverse while the rotation is being stopped.

4. The agitator of claim 1, wherein
the differential unit allocates the rotational drive forces from the drive source for the rotating shafts in proportion to loads exerted on the rotating shafts, and transmits the allocated rotational driving forces to each of the rotating shafts.

5. The agitator of claim 1, wherein
in the agitation vessel, a dimple process is applied to an internal surface surrounding the containing space.

6. The agitator of claim 1, wherein
in the agitation vessel, a discharge path is formed outwardly from a section, and a vicinity thereof, within an internal surface surrounding the containing space, the section lying, in a radial direction of rotation, furthest from a central axis of rotation.

7. The agitator of claim 6, wherein
the containing space is substantially spherical, and
the discharge path is formed outwardly from an equator of rotation, and a vicinity thereof, on the internal surface surrounding the containing space.

8. The agitator of claim 6, wherein
a valve operating mechanism operable to open and close the discharge path is positioned in the discharge path.

9. The agitator of claim 6, wherein
a guide cover for collecting the material discharged from the discharge path due to rotation of the agitation vessel is positioned, at or in a vicinity of an outer circumference of the agitation vessel, so as to correspond to an outer end of the discharge path.

10. The agitator of claim 9, further comprising:
a collection container operable to rotate in synchronization with the agitation vessel and collect the material discharged from the discharge path, wherein
the guide cover is rotatable in synchronization with both the agitation vessel and the collection container.

11. The agitator of claim 1, wherein
the agitation vessel is operable to contain a plurality of materials, and
the plurality of materials contained in the agitation vessel are agitated due to rotation of the agitation vessel.

12. The agitator of claim 1, wherein
the agitation vessel is operable to contain granular or aggregated material, and
the granular or aggregated material contained in the agitation vessel is pulverized due to rotation of the agitation vessel.
